(19) United States
(12) Patent Application Publication
(10) Pub. No.: US 2013/0064108 A1
(43) Pub. Date: Mar. 14, 2013

(54) System and Method for Relating Internet Usage with Mobile Equipment

(71) Applicants: Jacques Combet, Lavallois-Perret (FR); Gerard Hermet, Paris (FR)

(72) Inventors: Jacques Combet, Lavallois-Perret (FR); Gerard Hermet, Paris (FR)

(21) Appl. No.: 13/230,589

(22) Filed: Sep. 12, 2011

(51) Int. Cl. H04W 24/00

(52) U.S. Cl. 370/252

(57) ABSTRACT

A network intelligence solution (NIS) is arranged to access a stream of IP (Internet Protocol) packets associated with communications over a mobile communications network between mobile equipment employed by a user and a remote server such as a web server. When the mobile equipment accesses the network, the TAC (Type Allocation Code) portion of the IMEI (International Mobile Equipment Identity) is extracted from the IP stream at the NIS so that information about the mobile equipment such as technical information (e.g., manufacturer, model, operating system, etc.) and market data (e.g., market share, average sales price of the equipment, etc.) can be retrieved from one or more databases. The NIS performs deep packet inspection (DPI) to measure Internet usage by the mobile equipment user with each network access. Relationships between variables and/or observed data in each of the Internet usage data and mobile equipment information may then be identified.

### CROSS-REFERENCE TO RELATED APPLICATIONS

This application is related to U.S. patent applications respectively entitled “System and Method for Automated Classification of Web Pages and Domains”, “A Method for Segmenting Users of Mobile Internet”, and “Analyzing Internet Traffic by Extrapolating Socio-Demographic information from a Panel” each being filed concurrently herewith and owned by the assignee of the present invention, and the disclosure of which is incorporated by reference herein in its entirety.

### BACKGROUND

Communication networks provide services and features to users that are increasingly important and relied upon to meet the demand for connectivity to the world at large. Communication networks, whether voice or data, are designed in view of a multitude of variables that must be carefully weighed and balanced in order to provide reliable and cost effective offerings that are often essential to maintain customer satisfaction. Accordingly, being able to analyze network activities and manage information gained from the accurate measurement of network traffic characteristics is generally important to ensure successful network operations.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A network intelligence solution (NIS) is arranged to access a stream of IP (Internet Protocol) packets associated with communications over a mobile communications network between mobile equipment employed by a user and a remote server such as a web server. When the mobile equipment accesses the network, the TAC (Type Allocation Code) portion of the IMEI (International Mobile Equipment Identity) is extracted from the IP stream at the NIS so that information about the mobile equipment such as technical information (e.g., manufacturer, model, operating system, etc.) and market data (e.g., market share, average sales price of the equipment, etc.) can be retrieved from one or more databases. The NIS performs deep packet inspection (DPI) to measure Internet usage by the mobile equipment user with each network access. Relationships between variables and/or observed data in each of the Internet usage data and mobile equipment information may then be identified. In an illustrative example, correlations between equipment characteristics such as operating system type and Internet usage such as video consumption may be performed using the present system and method.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative mobile communications network environment that facilitates access to resources by users of mobile equipment and with which the present system and method may be implemented;

FIG. 2 shows an illustrative web browsing session which utilizes a request-response communication protocol;

FIG. 3 shows an illustrative NIS that may be located in a mobile communications network or node thereof and which extracts information from traffic flowing in the network illustratively including Internet usage measurements, the TAC associated with the mobile equipment, and/or other data;

FIG. 4 shows an illustrative deep packet inspection machine that may be utilized to perform measurements of Internet usage;

FIG. 5 shows application of an illustrative analysis engine that uses the TAC to identify information pertaining to the mobile equipment utilized in the mobile communications network environment;

FIG. 6 shows sets of illustrative variables for data that may be collected with regard to mobile equipment and Internet usage;

FIG. 7 shows use of an illustrative correlation engine for performing analyses of data including mobile equipment information and Internet usage measurements that are collected from the mobile communications network; and

FIG. 8 is a flowchart of an illustrative method for identifying relationships between mobile equipment and Internet usage.

Like reference numerals indicate like elements in the drawings. Unless otherwise indicated, elements are not drawn to scale.

### DETAILED DESCRIPTION

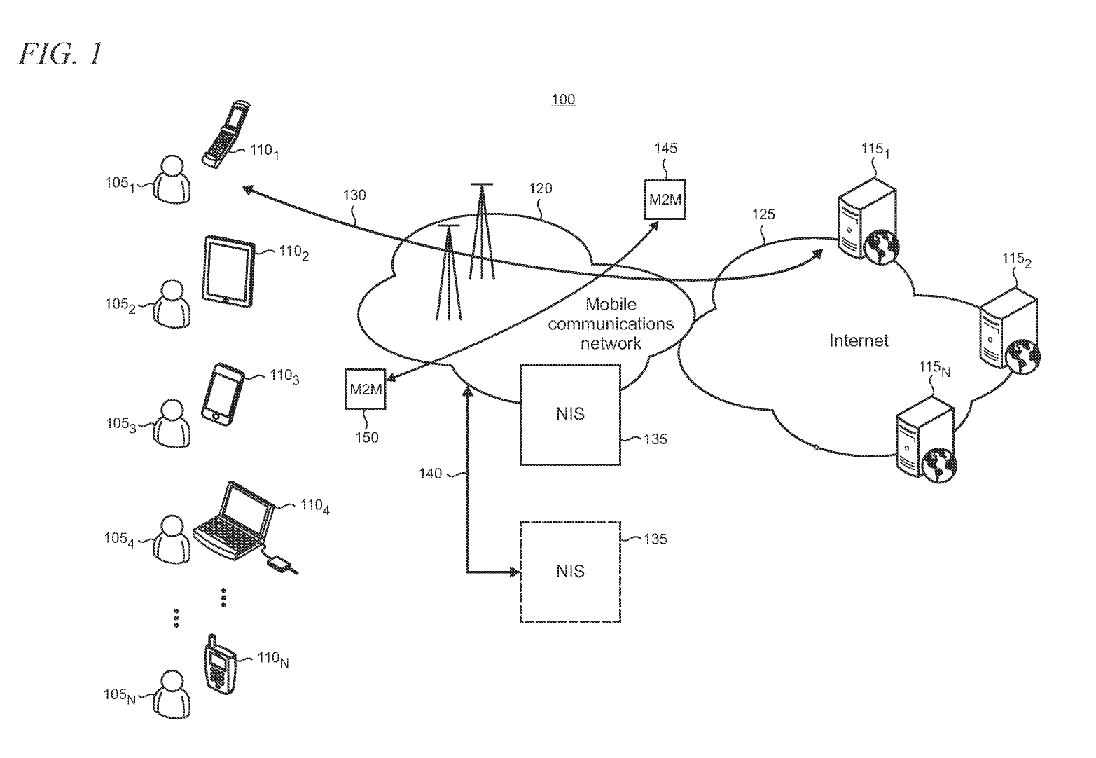

FIG. 1 shows an illustrative mobile communications network environment 100 that facilitates access to resources by users 105_{1, 2 . . . N} of mobile equipment 110_{1, 2 . . . N} and with which the present system and method for relating Internet usage and mobile equipment may be implemented. In this example, the resources are web-based resources that are provided from various web servers 115_{1, 2 . . . N}. Access is implemented, in this illustrative example, via a mobile communications network 120 that is operatively connected to the web servers 115 via the Internet 125. It is emphasized that the present system and method are not necessarily limited in applicability to mobile communications network implementations and that other network types that facilitate access to the World Wide Web including local area and wide area networks, PSTNs (Public Switched Telephone Networks), and the like that may incorporate both wired and wireless infrastructure may be utilized in some implementations. In this illustrative example, the mobile communications network 120 may be arranged using one of a variety of alternative networking standards such as GPRS (General Packet Radio Service), UMTS (Universal Mobile Telecommunications System), GSM/EDGE (Global System for Mobile Communications/Enhanced Data rates for GSM Evolution), CDMA (Code Division Multiple Access), CDMA2000, or other 2.5G, 3G, 3G+, or 4G (2.5^{th} generation, 3^{rd} generation, 3^{rd} generation plus, and 4th generation, respectively) wireless standards, and the like.

The mobile equipment 110 may include any of a variety of conventional electronic devices or information appliances that are typically portable and battery-operated and which may facilitate communications using voice and data. For example, the mobile equipment 110 can include mobile phones (e.g., non-smart phones having a minimum of 2.5G capability), e-mail appliances, smart phones, PDAs (personal digital assistants), ultra-mobile PCs (personal computers), tablet devices, tablet PCs, handheld game devices, digital media players, digital cameras including still and video cameras, GPS (global positioning system) navigation devices, pagers, electronic devices that are tethered or otherwise coupled to a network access device (e.g., wireless data card, dongle, modem, or other device having similar functionality to provide wireless Internet access to the electronic device) or devices which combine one or more of the features of such devices. Typically, the mobile equipment 110 will include various capabilities such as the provisioning of a user interface that enables a user 105 to access the Internet 125 and browse and selectively interact with web pages that are served by the Web servers 115, as representatively indicated by reference numeral 130.

The network environment 100 may also support communications among machine-to-machine (M2M) equipment and facilitate the utilization of various M2Mapplications. In this case, various instances of peer M2M equipment (representatively indicated by reference numerals 145 and 150) or other infrastructure supporting one or more M2Mapplications will send and receive traffic over the mobile communications network 120 and/or the Internet 125. In addition to accessing traffic on the mobile communications network 120 in order to relate Internet usage with mobile equipment, the present arrangement may also be adapted to access M2M traffic traversing the mobile communications network 120. Accordingly, while the methodology that follows is applicable to an illustrative example in which Internet usage of mobile equipment users is measured, those skilled in the art will appreciate that a similar methodology may be used when M2M equipment is utilized.

A NIS 135 is also provided in the environment 100 and operatively coupled to the mobile communications network 120, or to a network node thereof (not shown) in order to access traffic that flows through the network or node. In alternative implementations, the NIS 135 can be remotely located from the mobile communications network 120 and be operatively coupled to the network, or network node, using a communications link 140 over which a remote access protocol is implemented.

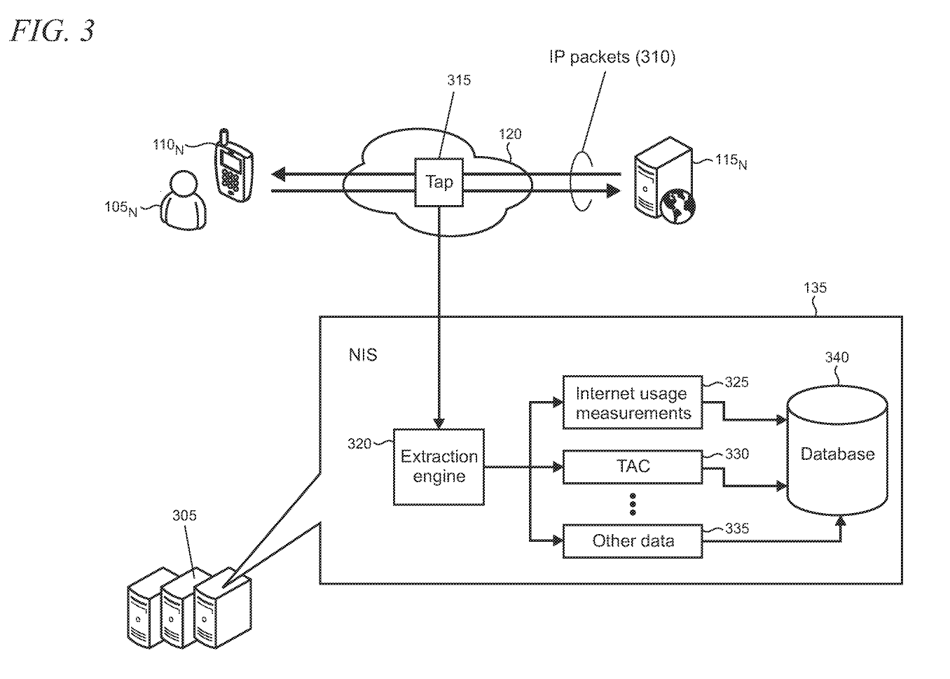

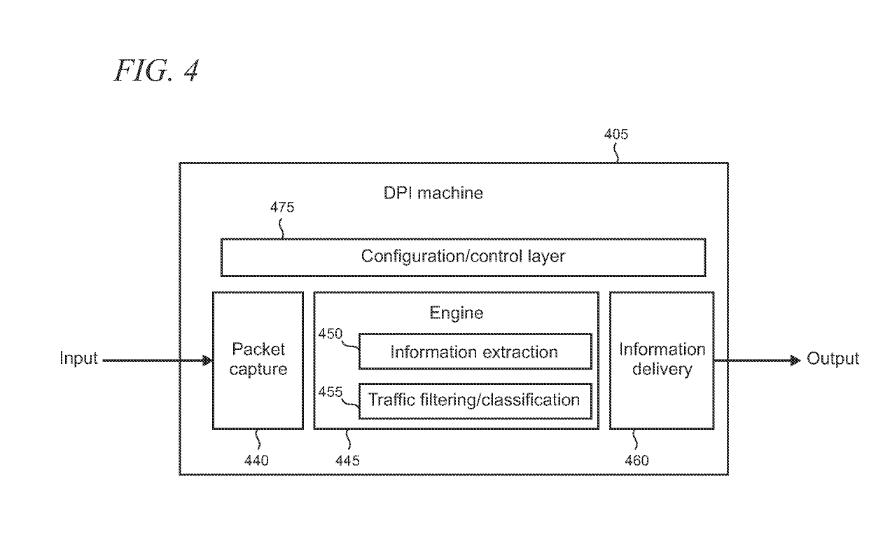

It is noted that performing network traffic analysis from a network-centric viewpoint can be particularly advantageous in many scenarios. For example, attempting to collect information at the client mobile equipment 110 can be problematic because such devices are often configured to utilize thin client applications and typically feature streamlined capabilities such as reduced processing power, memory, and storage compared to other devices that are commonly used for web browsing such as PCs. In addition, collecting data at the network advantageously enables data to be aggregated across a number of instances of mobile equipment 110, and further reduces intrusiveness and the potential for violation of personal privacy that could result from the installation of monitoring software at the client. The NIS 135 is described in more detail in the text accompanying FIGS. 3 and 4 below.

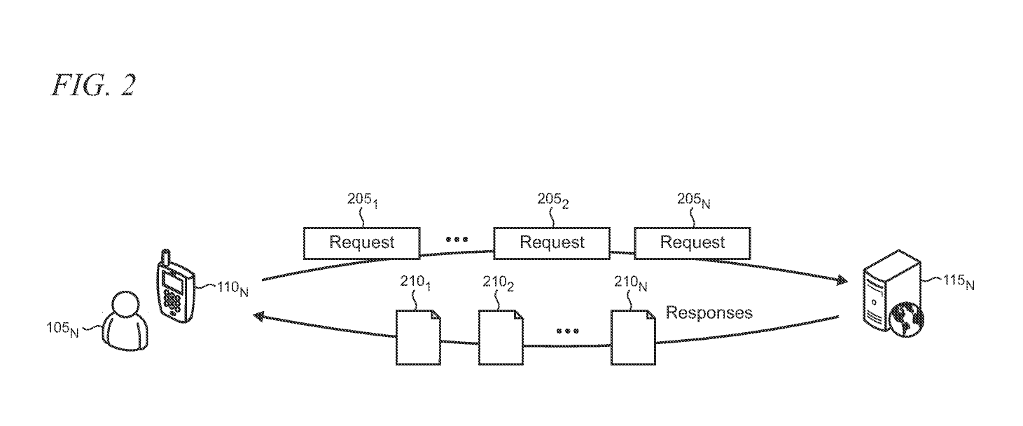

FIG. 2 shows an illustrative web browsing session which utilizes a protocol such as HTTP (HyperText Transfer Protocol) or SIP (Session Initiation Protocol). In this particular illustrative example, the web browsing session utilizes HTTP which is commonly referred to as a request-response protocol that is typically utilized to transfer Web files. Each transfer consists of file requests 205_{1, 2 . . . N} for pages or objects from a browser application executing on the mobile equipment 110 to a server 115 and corresponding responses 210_{1, 2 . . . N} from the server. Thus, at a high level, the user 105 interacts with a browser to request, for example, a URL (Uniform Resource Locator) to identify a site of interest, then the browser requests the page from the server 115. When receiving the page, the browser parses it to find all of the component objects such as images, sounds, scripts, etc., and then makes requests to download those objects from the server 115.

FIG. 3 shows details of the NIS 135 which is arranged, in this illustrative example, to extract and then analyze network traffic through the mobile communications network 120 in order to make measurements of Internet usage by the users 105 of the mobile equipment 110. The NIS 135 is typically configured as one or more software applications or code sets that are operative on a computing platform such as a server 305 or distributed computing system. In alternative implementations, the NIS 135 can be arranged using hardware and/or firmware, or various combinations of hardware, firmware, or software as may be needed to meet the requirements of a particular usage scenario. As shown, network traffic typically in the form of IP packets 310 flowing through the mobile communications network 120, or a node of the network, is captured via a tap 315. An extraction engine 320 takes the captured IP packets to extract various types of information including, for example, Internet usage measurements 325, the TAC 330, and/or other data 335. The extracted information can be written to one or more databases (representatively indicated by reference numeral 340) in typical implementations.

As shown in FIG. 4, the NIS 135 can be implemented, at least in part, using a deep packet inspection (“DPI”) machine 405. DPI machines are known and commercially available examples include the ixMachine produced by Qosmos SA. The IP packets 310 (FIG. 3) are collected in a packet capture component 440 of the DPI machine 405. An engine 445 takes the captured IP packets to extract various types of information, as indicated by reference numeral 450, and filter and/or classify the traffic, as indicated by reference numeral 455. An information delivery component 460 of the DPI machine 405 then outputs the data generated by the DPI engine 445. Software code may execute in a configuration and control layer 475 in the DPI machine 405 to control the DPI engine output and information delivery

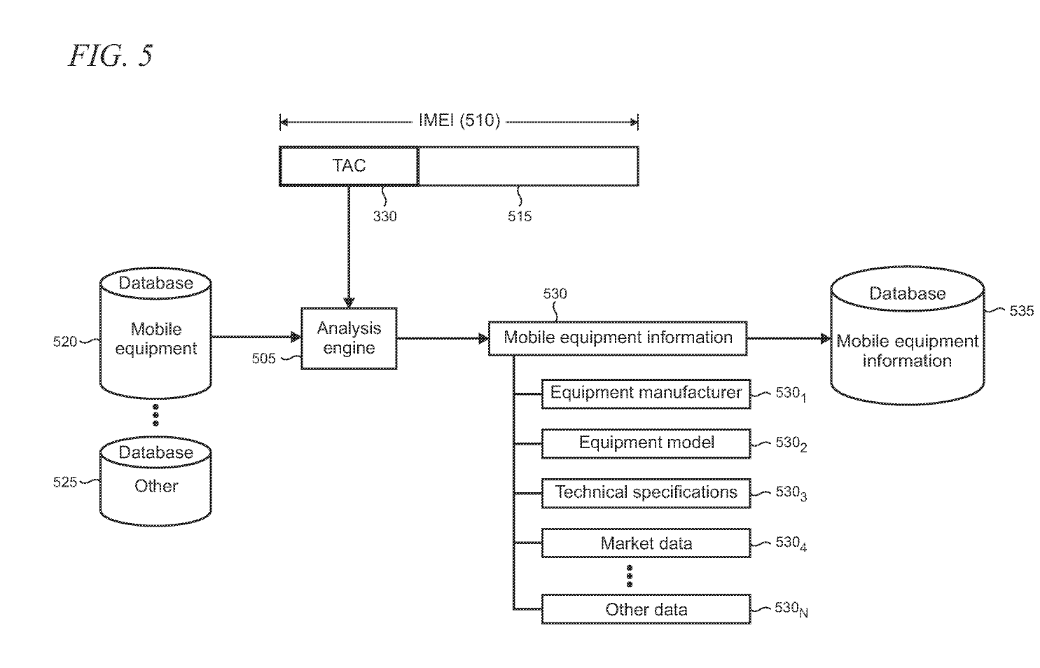

FIG. 5 shows application of an illustrative analysis engine 505 that uses the TAC portion of the IMEI (International Mobile Equipment Identity) 510 to identify information pertaining to the mobile equipment 110 (FIG. 1) utilized in the mobile communications network environment 100. The IMEI and TAC are defined by the 3GPP (3^{rd} Generation Partnership Project) standard for mobile broadband under GSM (Global System for Mobile Communications). The mobile equipment 110 will typically transmit the IMEI to the mobile communications network 120 with each network access. The analysis engine 505 may be implemented in the NIS 135 (FIG. 1) using functionality provided by the DPI machine 405 (FIG. 4) or as standalone functionality in some instances.

It is noted that the TAC 330 may be extracted from the IP packet stream 310 (FIG. 3) without extracting the entire IMEI 510. Alternatively, various other portions of the IMEI, identified by reference numeral 515 in FIG. 5, may be extracted along with the TAC 330. Under 3GPP, the TAC is currently the initial eight digits of the IMEI which itself is 14 digits plus a check digit or 16 digits for the IMEISV (IMEI Software Version). The TAC uniquely identifies the mobile equipment manufacturer and model. TAC databases or lookups exist and are available for remote access or, in some applications, a TAC database can be instantiated and maintained locally to the NIS 135. An illustrative mobile equipment database that includes mobile equipment lookups by TAC is represented in FIG. 5 by reference numeral 520. The database 520 may also include additional information beyond manufacturer and model of the mobile equipment. Alternatively, the information in database 520 may be supplemented by one or more additional databases as representatively indicated by reference numeral 525.

The analysis engine 505 can thus take the TAC 330 extracted from the IP traffic to identify a variety of types and kinds of information about the particular mobile equipment 110 a given user 105 is utilizing to access the mobile communications network 120 (FIG. 1). As shown in FIG. 5, the mobile equipment information 530 output from the analysis engine 505 may include, for example, the mobile equipment manufacturer 530₁; the model 530₂ of the mobile equipment; various product specification criteria or technical specifications for the mobile equipment 530₃ including features, capabilities, and the like; market data 530₄; and other data 530_{N}. The market data 530₄ could include, for example, information relating to sales volume of the particular mobile equipment (i.e., popularity), typical sales price for the mobile equipment, market share and growth rate, competitive mobile equipment, usage trends, and the like. Such market data may include other dimensions such as popularity by country/region, by user demographic—age, gender, household income, education, etc., by mobile carrier, etc. The analysis engine may typically write the results of the analysis (i.e., the mobile equipment information 530) to a mobile equipment information database 535.

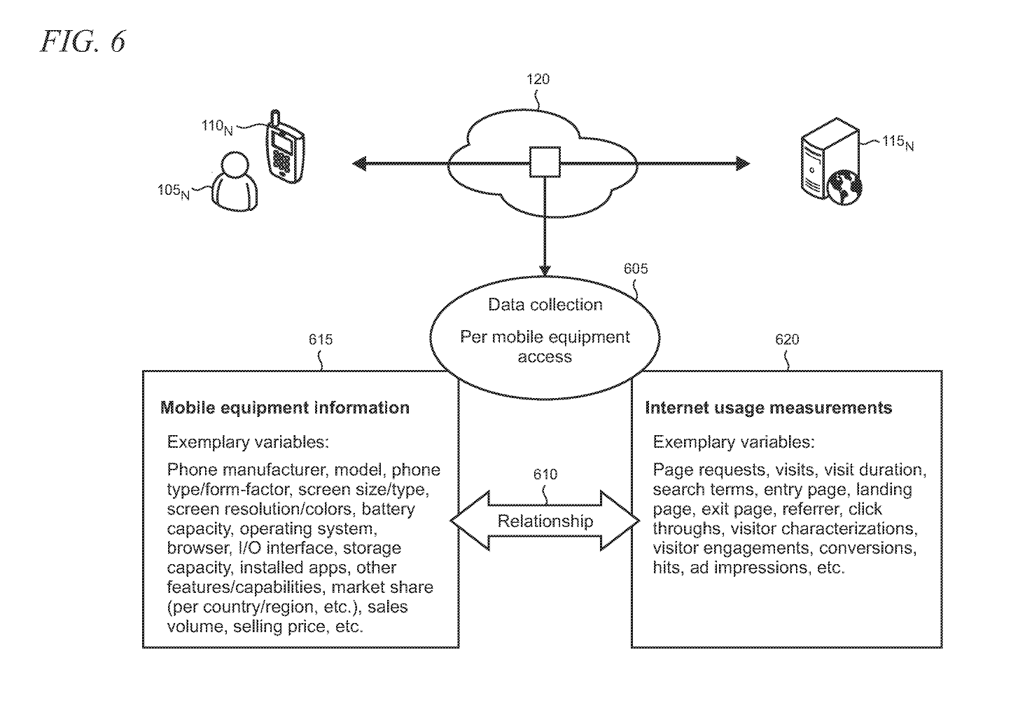

As shown in FIG. 6, data representing the TAC and Internet usage measurements is typically collected each time the mobile communications network 120 is accessed by the mobile equipment 110 employed by the user 105. That is, Internet usage measurements are collected per mobile equipment (as indicated by reference numeral 605) which enables the information about particular mobile equipment to be related with Internet usage (as indicated by arrow 610 in FIG. 6). Typically, the association will be quantified using statistical analyses. Exemplary mobile equipment variables 615 include manufacturer, model, equipment type/form-factor (e.g., smart phone, non-smart basic phone, physical keyboard-equipped, non-equipped, etc.), screen size and type (e.g., touchscreen, non-touchscreen), screen colors and resolution, operating system, mobile browser type, input/output (I/O) interfaces (e.g., Bluetooth compatibility), storage capacity, manufacturer-installed apps (applications), equipment features and capabilities (e.g., navigation, camera, memory card compatibility, WiFi enabled, etc.), equipment market share and growth (per country/region, per user demographic, etc.), sales volume and growth, average/typical equipment selling price, and the like.

Exemplary Internet usage variables 620 include page requests, visits, visit duration, search terms, entry page, landing page, exit page, referrer, click through, visitor characterizations, visitor engagements, conversions, hits, ad impressions, and the like. It is emphasized that the exemplary variables shown in FIG. 6 are intended to be illustrative and that the number and particular variables that are utilized in any given application can differ from what is shown as required by the needs of a given application.

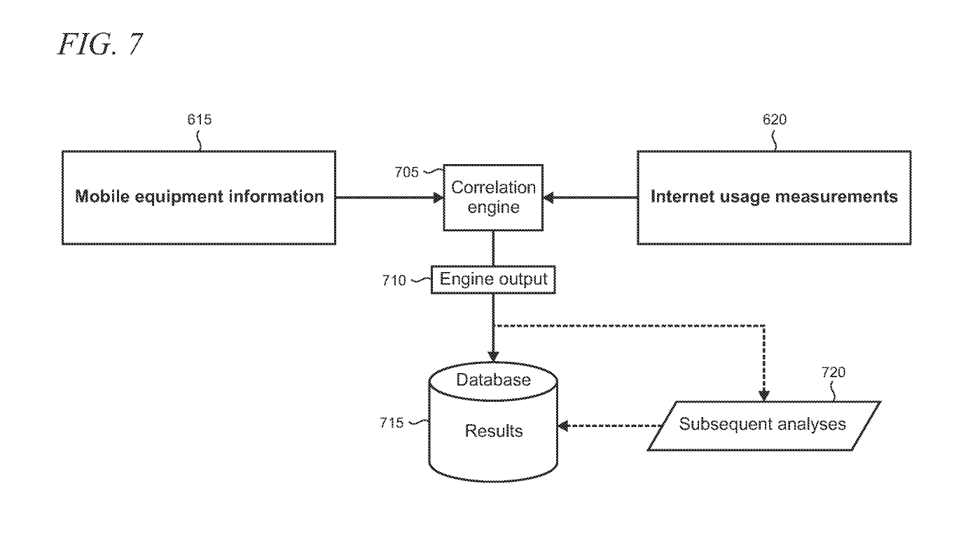

FIG. 7 shows one example of an arrangement for analyzing mobile equipment information and Internet usage measurements. In this example, a correlation engine 705 is utilized so that one or more variables included in the mobile equipment information 615 can be correlated to one or more variables included in the Internet usage measurements 620. For example, analysis of the data may indicate the strength of correlation between mobile equipment screen size (i.e., a technical specification/feature of a given phone) and the amount of video content consumed (i.e., an Internet usage metric). Another example is to identify the strength of correlation between the mobile equipment operating system and video consumption (e.g., do Android OS users consume more video than Apple iPhone users?). It is emphasized that the preceding examples are merely illustrative and that a wide variety of different analyses, associations, or correlations may be performed on the collected mobile equipment and Internet usage measurements as may be needed to meet the requirements of a particular application.

The correlation engine 705 may be implemented in the NIS 135 (FIG. 1) using functionality provided by the DPI machine 405 (FIG. 4) or as standalone functionality in some instances. The output 710 from the correlation engine 705 may be written to a results database 715 or transmitted to a remote destination in some cases. Alternatively, subsequent analyses may be performed, as indicated by reference numeral 720.

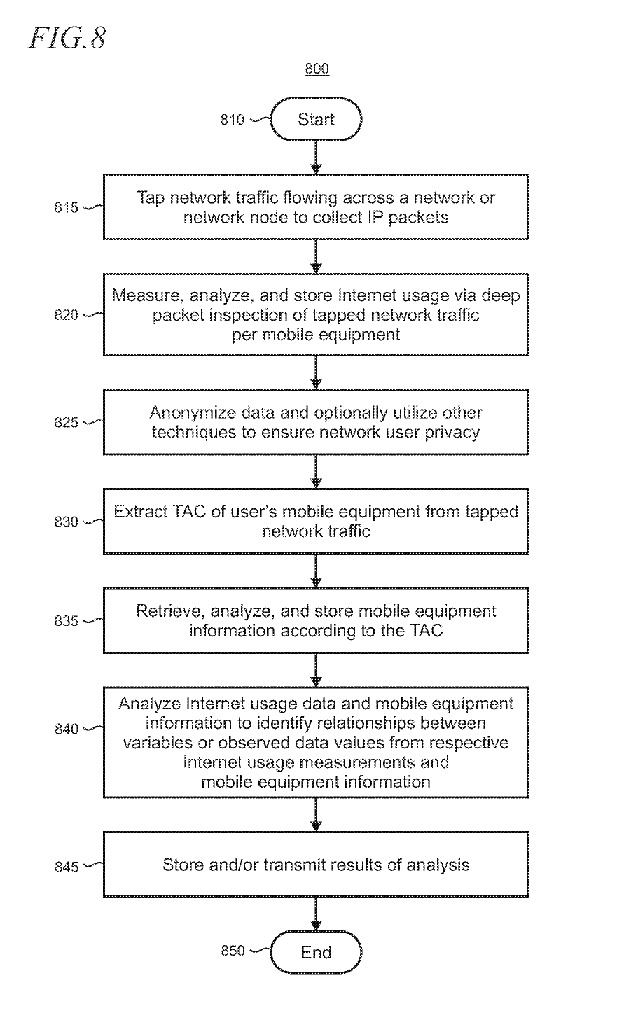

FIG. 8 shows a flowchart of an illustrative method 800 for relating Internet usage and mobile equipment. The method begins at block 810. At block 815, traffic flowing across a network or network node is tapped to collect IP packets. At block 820, Internet usage is measured, analyzed, and stored typically using deep packet inspection on a per mobile equipment basis where exemplary metrics for the measurement and analysis are shown in FIG. 6 by reference numeral 620. At block 825, data utilized by the NIS 135 (FIGS. 1 and 3), or portions thereof can be anonymized to remove identifying information from the data, for example, to ensure that privacy of the network access device users is maintained. It is emphasized that while the method step in block 825 is shown as occurring after block 820, the anonymization described here may generally be included as part of the step shown in block 820 or alternatively applied to the captured data at any point in the method 800. Other techniques may also be optionally utilized in some implementations to further enhance privacy including, for example, providing notification to the users 105 that certain anonymized data may be collected and utilized to enhance network performance or improve the variety of features and services that may be offered to users in the future, and providing an opportunity to opt out (or opt in) to participation in the collection.

End-user privacy may be preserved by irreversibly anonymizing all Personally Identifiable Information (PII) present in the extracted data. This anonymization takes into account both direct and indirect exposure of user privacy by applying a multitude of methods. Direct PII refers to names, numbers, and addresses that could as such identify an individual end-user, while indirect PII refers to the use of rare devices, applications, or content that could potentially identify an individual end-user.

Confidentiality of communications is fully respected and maintained in the present arrangement, as no private communications content is collected. More specifically, the majority of data is extracted from packet headers, and data from packet payloads is extracted only on specific cases where part of the payload in question is known to be public content, such as in the case of traffic sent in known format by known advertising servers. The data is collected by default on a census basis, but mechanisms for filtering in the data of opt-in end-users and filtering out the data of opt-out users are also supported.

The TAC of the user's mobile equipment is extracted from the tapped network traffic at block 830 in FIG. 8. At block 835, mobile equipment information is retrieved according to the TAC which may be analyzed, and stored. The mobile equipment information can include manufacturer, model, technical specifications, market data, and other data as shown in FIG. 5 and described in the accompanying text, and exemplary mobile equipment variables are shown in FIG. 6 by reference numeral 615. At block 840 in FIG. 8, the Internet usage data and mobile equipment information resulting from the steps in blocks 820 and 835 may be analyzed to identify relationships between variables or observed data from the respective measurements and information. Such analyses may include statistical analyses such as correlation and association. The results of the analyses may be stored or transmitted to remote locations at block 845. The method ends at block 850.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for relating information about mobile equipment employed by a user to Internet usage, the method comprising the steps of:
tapping a stream of IP packets comprising traffic traversing a network between the mobile equipment and one or more remote Internet servers;
measuring Internet usage by the mobile equipment by inspecting the IP packet stream;
extracting at least the TAC portion of the IMEI of the mobile equipment from the IP packet stream, the IMEI being transmitted by the mobile equipment to the network upon access to the network;
identifying the information about the mobile equipment from the extracted TAC, the information including technical specifications or market data; and
relating the technical specifications or market data to the Internet usage measurements.

2. The method of claim 1 in which the inspecting comprises performing deep packet inspection.

3. The method of claim 1 in which the relating comprises statistical analysis selected from at least one of correlation or association.

4. The method of claim 1 in which the market data comprises one of market share, market growth, sales volume, sales growth, or average or typical equipment selling price.

5. The method of claim 4 in which the market data is dimensioned by one of country, region, or user demographic.

6. The method of claim 1 in which the technical specifications comprise at least one of manufacturer, model, equipment type, form-factor, screen size, screen type, screen colors, screen resolution, operating system, mobile browser type, I/O interfaces, storage capacity, manufacturer-installed applications, equipment features or equipment capabilities.

7. The method of claim 1 in which the tapped stream of IP packets is subjected to anonymization so that privacy of users of the mobile equipment is maintained.

8. The method of claim 1 further including a step of transmitting results of the relating.

9. One or more computer-readable storage media containing instructions which, when executed by one or more processors disposed in an electronic device implement a network intelligence solution, comprising:
a tap disposed in a node of a mobile communications network, the tap configured for tapping a stream of IP packets that traverse the node between multiple instances of mobile equipment and web servers on the Internet;
a deep packet inspection machine for i) extracting the TAC of the mobile equipment from the IP packets and for ii) measuring Internet usage by each instance of the mobile equipment during web-browsing sessions;
an analysis engine for retrieving information pertaining to each instance of the mobile equipment; and
a correlation engine for correlating variables or observed data in the Internet usage measurements to variables or observed data in the mobile equipment information.

10. The one or more computer-readable storage media of claim 9 further including a database to which the correlation engine writes correlation data.

11. The one or more computer-readable storage media of claim 9 in which the Internet usage measurements include one or more of page requests, visits, visit duration, search terms, entry page, landing page, exit page, referrer, click through, visitor characterizations, visitor engagements, conversions, hits, or ad impressions.

12. The one or more computer-readable storage media of claim 9 in which the mobile equipment comprises one of mobile phone, e-mail appliance, smart phone, non-smart phone, M2M equipment, PDA, PC, ultra-mobile PC, tablet device, tablet PC, handheld game device, digital media player, digital camera, GPS navigation device, pager, wireless data card, wireless dongle, wireless modem, or device which combines one or more features thereof.

13. The one or more computer-readable storage media of claim 9 further comprising a communications link to facilitate the network intelligence solution to be remotely located from the node.

14. The one or more computer-readable storage media of claim 9 in which the TAC is extracted and Internet usage is measured with each access of the mobile communications network by the mobile equipment.

15. A computer-implemented method for associating mobile Internet usage data with mobile equipment information, the method comprising the steps of:
collecting mobile Internet usage of a mobile communications network having a plurality of subscribers by each subscriber's mobile equipment;
extracting the mobile equipment's TAC from an IMEI at each Internet access; and
generating correlations between mobile Internet usage and mobile equipment information identified responsively to the extracted TAC.

16. The computer-implemented method of claim 15 in which the collecting is performed during web-browsing sessions.

17. The computer-implemented method of claim 15 in which the collecting is performed by tapping IP traffic traversing a network node.

18. The computer-implemented method of claim 17 in which the extracting and generating are performed in a network intelligence solution.

19. The computer-implemented method of claim 18 in which the network intelligence solution is non-co-located with the network node.

20. The computer-implemented method of claim 15 in which the mobile equipment information includes at least one of sales volume data, market share data, or production specification criteria.
